(19) United States
(12) Patent Application Publication
(10) Pub. No.: US 2024/0412156 A1
(43) Pub. Date: Dec. 12, 2024

(54) DELIVERY ASSISTANCE METHOD

(71) Applicant: TOYOTA JIDOSHA KABUSHIKI KAISHA, Aichi-ken (JP)

(72) Inventors: Yohei NAKANISHI, Nagoya-shi (JP); Toshiharu FUKUMURA, Nagakute-shi (JP); Adrian NICOL, Nagoya-shi (JP); Ryuichi DANNO, Kasugai-shi (JP); Toshinori KIMURA, Ichinomiya-shi (JP); Yoshiaki ABE, Kofu-shi (JP)

(21) Appl. No.: 18/736,538

(22) Filed: Jun. 7, 2024

(30) Foreign Application Priority Data
Jun. 12, 2023 (JP) 2023-096389

(51) Int. Cl. G06Q 10/0836

(52) U.S. Cl. CPC G06Q 10/0836

(57) ABSTRACT

A delivery assistance method is for assisting a delivery person in delivering luggage addressed to a customer who receives a luggage delivery service to a luggage locker installed at a location designated by the customer. The delivery assistance method includes: acquiring, with a control device, location candidates selected by the customer as a candidate for a pickup location of the luggage; acquiring, with the control device, locker information including availability of the luggage locker installed at each of the location candidates; selecting, with the control device, a location candidate at which the luggage locker is available from the location candidates as a delivery destination of the luggage based on the locker information; and notifying, with a communication device, the customer of the delivery destination, which is selected with the control device.

### CROSS-REFERENCE TO RELATED APPLICATIONS

This application is based upon and claims the benefit of priority from prior Japanese Patent Application No. 2023-096389, filed on Jun. 12, 2023, the entire contents of which are incorporated herein by reference.

### BACKGROUND

### 1. Field

The present disclosure relates to a delivery assistance method.

### 2. Description of Related Art

Japanese Laid-Open Patent Publication No. 2019-119586 discloses a control device that delivers luggage from a delivery origin to a delivery destination using an unmanned transport machine. When a failure occurs on a delivery route from the delivery origin to the delivery destination, the control device causes a recipient of the luggage to select one from different delivery methods. Then, the control device determines a new delivery destination on the basis of the selection result of the delivery method.

In recent years, luggage lockers have been installed at various locations. Therefore, as a luggage delivery method, for example, a method in which a delivery person delivers luggage to a luggage locker installed at a location selected by the recipient of the luggage among different locations is considered. In this case, when the luggage locker at the location selected by the recipient is not available, the delivery person cannot store the luggage in the luggage locker.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In an aspect of the present disclosure, a delivery assistance method is for assisting a delivery person in delivering luggage addressed to a customer who receives a luggage delivery service to a luggage locker installed at a location designated by the customer. The delivery assistance method includes: acquiring, with processing circuitry, location candidates selected by the customer as a candidate for a pickup location of the luggage; acquiring, with the processing circuitry, locker information including availability of the luggage locker installed at each of the location candidates; selecting, with the processing circuitry, a location candidate at which the luggage locker is available from the location candidates as a delivery destination of the luggage based on the locker information; and notifying, with a communication device, the customer of the delivery destination, which is selected by the processing circuitry.

Other features and aspects will be apparent from the following detailed description, the drawings, and the claims.

### BRIEF DESCRIPTION OF THE DRAWINGS

FIG. 1 is a schematic configuration diagram illustrating a delivery assistance device, a plurality of information terminals, and a plurality of luggage lockers in a delivery assistance method of a first embodiment.

FIG. 2 is a sequence diagram showing a flow of a plurality of processes constituting the delivery support method of the first embodiment of FIG. 1.

FIG. 3 is a flowchart showing a process of determining a delivery destination in the delivery assistance method of the first embodiment of FIG. 1.

FIG. 4 is a flowchart showing a process of determining a delivery destination in the delivery assistance method of the second embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

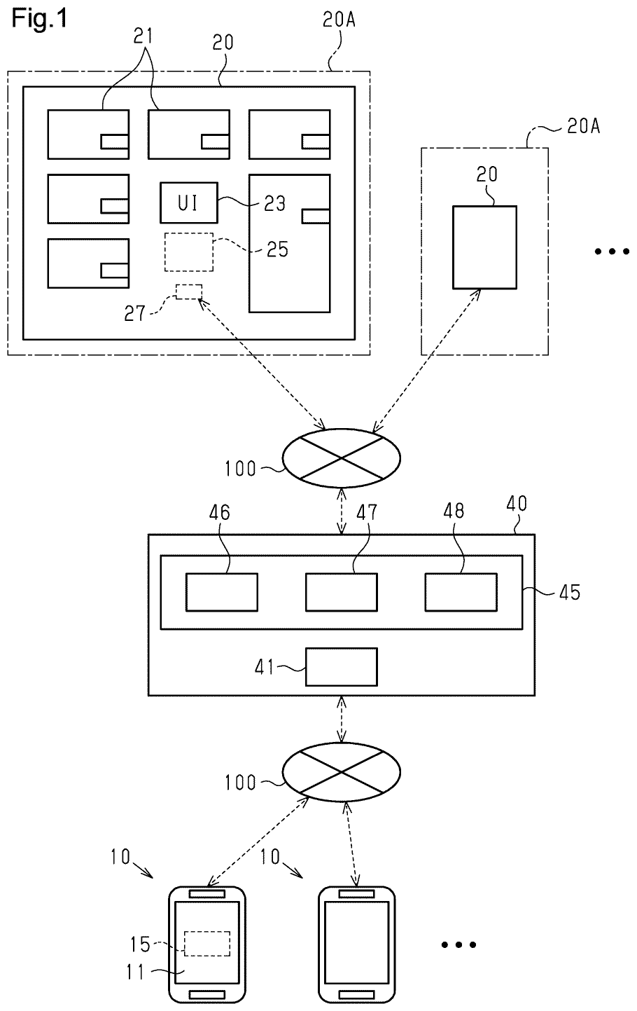

Hereinafter, a first embodiment of a delivery assistance method will be described with reference to FIGS. 1 to 3.

FIG. 1 illustrates a delivery assistance device 40, a plurality of information terminals 10, and a plurality of luggage lockers 20.

### Information Terminal

The information terminal 10 is an electronic device owned by a customer who receives a luggage delivery service. The information terminal 10 can transmit and receive various kinds of information to and from the delivery assistance device 40 via the communication network 100. Examples of the information terminal 10 include a smartphone, a tablet terminal, and a personal computer.

The information terminal 10 includes a user interface 11 and processing circuitry 15. The user interface 11 includes a display screen and an operation unit. An example of the processing circuitry 15 is an electronic control device. When the operation unit is operated by the user, the processing circuitry 15 executes a process corresponding to the operation. Then, the processing circuitry 15 transmits information indicating an execution result of the process to the delivery assistance device 40 via the communication network 100. When the information terminal 10 receives information from the delivery assistance device 40 via the communication network 100, the processing circuitry 15 displays the information received by the information terminal 10 on the display screen of the user interface 11.

### Luggage Locker

The luggage locker 20 is installed in various locations 20A such as in the premises of stations and in towns. The location 20A where the luggage locker 20 is installed is referred to as an “installation location 20A.”

The luggage locker 20 has a plurality of boxes 21 capable of storing baggage. That is, the luggage locker 20 is an assembly of a plurality of boxes 21. The luggage locker 20 includes a user interface 23 and processing circuitry 25.

The user interface 23 includes a display screen and an operation unit. A user of the luggage locker 20 operates the operation unit while viewing the display on the display screen when the user stores luggage in the box 21. When the door of the box 21 is opened by the operation, the user can store the baggage in the box 21. Further, when the user takes out the luggage from the box 21, the user operates the operation unit while viewing the display on the display screen. When the door of the box 21 is opened by this operation, the user can take out the luggage from the box 21.

An example of the processing circuitry 25 is an electronic control device. The processing circuitry 25 executes processing according to the operation of the operation unit by the user. The processing circuitry 25 can grasp the use situation of the luggage locker 20. For example, the processing circuitry 25 grasps the number of used boxes 21 and the number of unused boxes 21 among the plurality of boxes 21. That is, the processing circuitry 25 can grasp the use ratio of the luggage locker 20. Here, the “use ratio” is a value obtained by dividing the number of used boxes 21 by the total number of boxes 21 in the luggage locker 20.

The luggage locker 20 has a function of communicating with the delivery assistance device 40. That is, the luggage locker 20 includes the communication device 27. The communication device 27 outputs information received from the delivery assistance device 40 via the communication network 100 to the processing circuitry 25. The communication device 27 transmits information output from the processing circuitry 25 to the delivery assistance device 40 via the communication network 100.

### Delivery Assistance Device

The delivery assistance device 40 includes a communication device 41 and a control device 45 which is a processing circuit.

The communication device 41 is an interface of the delivery assistance device 40 for transmitting and receiving information to and from an external communication device via the communication network 100. The communication device 41 outputs information received via the communication network 100 to the control device 45. The communication device 41 transmits information output by the control device 45 to the information terminal 10 or the luggage locker 20 via the communication network 100.

An example of the control device 45 is an electronic control device. The control device 45 includes a CPU 46, a first memory 47, and a second memory 48. The first memory 47 stores a control program executed by the CPU 46. The second memory 48 stores a calculation result of the CPU 46, information received by the communication device 41, and the like.

When the CPU 46 executes the control program stored in the first memory 47, the control device 45 selects the luggage locker 20 in which the luggage is to be stored from the plurality of luggage lockers 20. The control device 45 sets the installation location 20A where the selected luggage locker 20 is installed as the delivery destination of the luggage. Then, the control device 45 notifies the customer of the set delivery destination and information necessary for taking out the luggage from the luggage locker 20 installed at the delivery destination. Specific contents of such a series of processes will be described later. The information necessary for taking out the luggage from the luggage locker 20 includes, for example, the number and the password of the box 21 in which the luggage is stored.

### Delivery Assistance Method

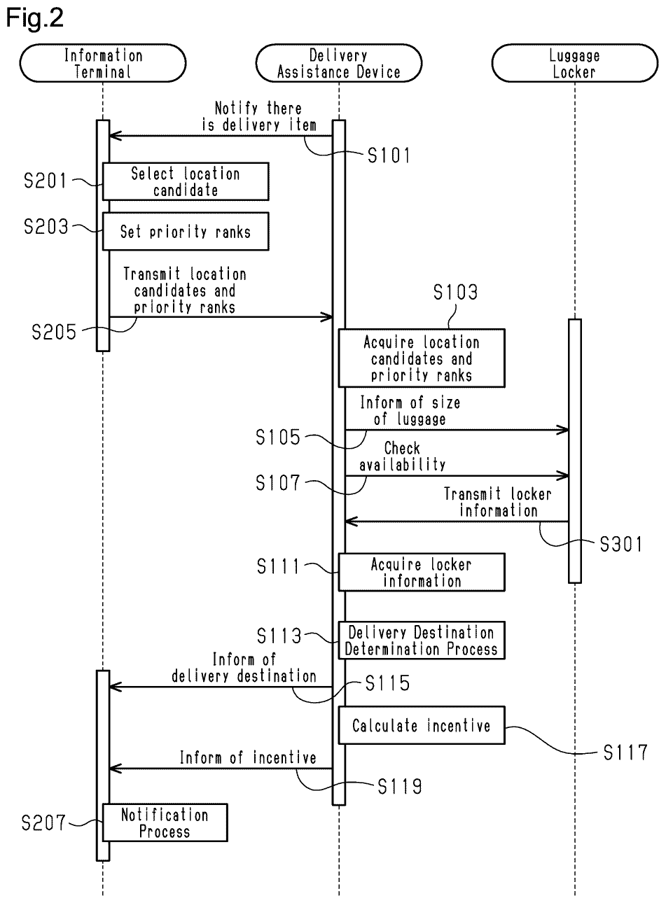

The delivery assistance method will be described with reference to FIG. 2. This delivery assistance method is a method for assisting a delivery person in delivering luggage to the luggage locker 20 installed in the installation location 20A designated by the customer.

In step S101, the communication device 41 of the delivery assistance device 40 transmits information indicating that there is a delivery item to the customer to the information terminal 10 of the customer.

When the information terminal 10 receives the information, the processing circuitry 15 of the information terminal 10 executes the process of step S201. In step S201, the processing circuitry 15 executes a process for causing the customer to select a location candidate from among the installation locations 20A. The location candidate is an installation location 20A at which the customer desires to receive the luggage.

For example, in step S201, the processing circuitry 15 causes the display screen of the user interface 11 to display a screen for allowing the customer to select a location candidate. The customer operates the operation unit of the user interface 11 while viewing the display screen, thereby selecting different location candidates. The processing circuitry 15 acquires the location candidates selected by the operation of the operation unit by the customer.

In the present embodiment, when the customer is caused to select a location candidate as described above, the customer can set a priority rank for each of the selected location candidates.

In step S203, the processing circuitry 15 of the information terminal 10 sets a priority rank for each of the location candidates based on the operation result of the operation unit of the user interface 11 by the customer.

In step S205, the information terminal 10 transmits information on the location candidates and the priority ranks to the delivery assistance device 40.

When the communication device 41 of the delivery assistance device 40 receives the information regarding the location candidates and the priority ranks from the information terminal 10, the control device 45 of the delivery assistance device 40 executes the process of step S103. In step S103, the control device 45 acquires the location candidates selected by the customer. In addition, the control device 45 acquires the priority ranks set by the customer for the location candidates. The control device 45 stores the location candidates and the priority rank for each of the location candidates associated with each other in the second memory 48.

In the next step S105, the communication device 41 of the delivery assistance device 40 transmits information regarding the size of the luggage, which is a delivery item to the customer, to the luggage locker 20 installed at the location candidate. When multiple locations are set as the location candidates, the communication device 41 transmits the information to the luggage locker 20 installed at each of the location candidates.

In step S107, the communication device 41 transmits a command for checking the availability of the luggage locker 20 to each of the luggage lockers 20.

When the communication device 27 of the luggage locker 20 receives the information transmitted from the delivery assistance device 40 in steps S105 and S107, the processing of step S301 is executed in the luggage locker 20. In step S301, the communication device 27 transmits locker information to the delivery assistance device 40 in response to the information received from the delivery assistance device 40. The locker information includes the availability of the luggage locker 20. An example of the availability is a use ratio of the luggage locker 20. The locker information also includes information on whether there is a box 21 available and capable of storing the luggage, which is a delivery item to the customer.

When the communication device 41 of the delivery assistance device 40 receives the locker information from each luggage locker 20, the control device 45 executes the process of step S111.

In step S111, the control device 45 acquires the locker information received by the communication device 41. For example, the control device 45 stores the locker information in the second memory 48.

In step S113, the control device 45 executes a determination process for determining one location candidate from among the location candidates as the delivery destination of the luggage. Details of the delivery destination determination process will be described later.

In the next step S115, the communication device 41 transmits information on the delivery destination to the information terminal 10. That is, the communication device 41 notifies the customer of the delivery destination selected by the control device 45. The information on the delivery destination includes the installation location 20A set as the delivery destination and information necessary for receiving the luggage from the luggage locker 20 installed at the installation location 20A.

In step S117, the control device 45 calculates an incentive provided to the customer. For example, the control device 45 calculates the incentive such that the incentive is increased as the location candidate selected as the delivery destination has a lower priority rank. An example of the incentive is points that can be used in various services such as shopping. In step S119, the communication device 41 transmits information on the incentive calculated by the control device 45 to the information terminal 10.

When the information terminal 10 receives the information transmitted from the delivery assistance device 40 in steps S115 and S119, the processing circuitry 15 of the information terminal 10 executes the process of step S207. In step S207, the processing circuitry 15 executes a notification process for notifying the customer of the delivery destination and the incentive. For example, the processing circuitry 15 displays the delivery destination and the incentive on the display screen of the user interface 11 in the notification process.

### Delivery Destination Determination Process

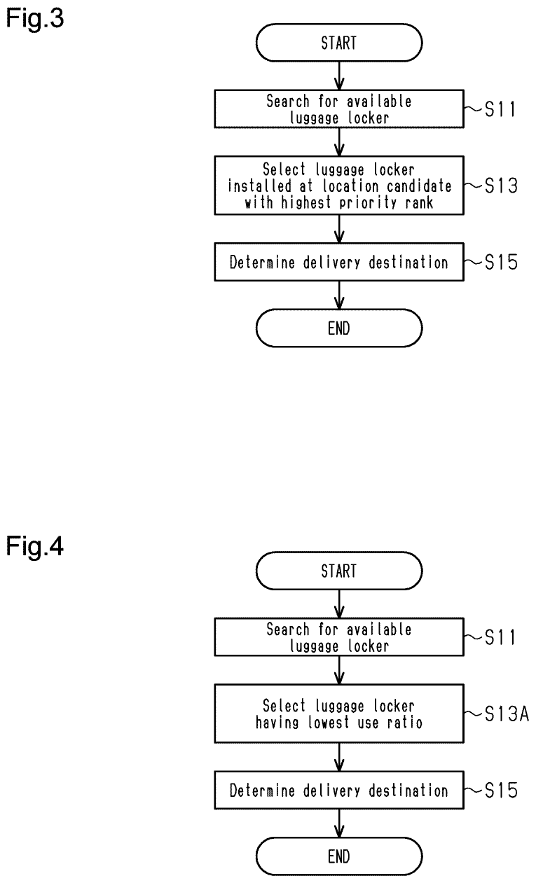

With reference to FIG. 3, the process of determining the delivery destination described in step S113 will be described.

In step S11, the control device 45 of the delivery assistance device 40 searches for an available luggage locker 20 among the luggage lockers 20 that have transmitted locker information. The available luggage locker 20 refers to a luggage locker 20 of which the use ratio is not 100%. A luggage locker 20 of which the use ratio is 100% refers to an “occupied luggage locker 20.”

In the next step S13, the control device 45 selects one luggage locker 20 from the available luggage lockers 20 based on the priority ranks set by the customer. For example, in a case where two or more luggage lockers 20 are available, the control device 45 selects one of the luggage lockers 20 installed at the location candidate having the highest priority rank among the available luggage lockers 20. For example, in a case where there is only one available luggage locker 20, the control device 45 selects the luggage locker 20.

In subsequent step S15, the control device 45 selects the installation location 20A of the luggage locker 20 selected in step S13 as the delivery destination. Thereafter, the control device 45 ends the determination process.

### Operation and Effects of Present Embodiment

(1-1) When the customer is notified that there is a delivery item from the delivery assistance device 40, the customer selects a plurality of location candidates by operating the information terminal 10 of the customer. When the information on the location candidates is transmitted from the information terminal 10 to the delivery assistance device 40, the control device 45 of the delivery assistance device 40 acquires the location candidates selected by the customer.

The control device 45 of the delivery assistance device 40 confirms the availability in the plurality of luggage lockers 20. The communication device 27 of the luggage locker 20 transmits the locker information including the availability to the delivery assistance device 40. Accordingly, the control device 45 of the delivery assistance device 40 can recognize the available luggage locker 20 among the plurality of luggage lockers 20.

The control device 45 selects the location candidate in which the available luggage locker 20 is installed as the delivery destination from the location candidates selected by the customer. Then, the communication device 41 transmits information on the delivery destination determined by the control device 45 to the information terminal 10 of the customer.

The delivery person of the luggage heads for the installation location 20A determined as the delivery destination. Then, the delivery person stores the luggage in the box 21 of the luggage locker 20 at the installation location 20A. Thus, the customer can take out the luggage addressed to the customer from the box 21 of the luggage locker 20 by going to the installation location 20A determined as the delivery destination. That is, the customer can receive the luggage at the delivery destination.

Therefore, according to the delivery assistance method of the present embodiment, it is possible to suppress the occurrence of a situation in which the parcel cannot be delivered to the customer because the luggage locker 20 installed at the installation location 20A designated by the customer is not available.

(1-2) When selecting a location candidate from among a plurality of installation locations 20A, the customer can set priority ranks for each location candidate. Information on the priority rank is transmitted from the information terminal 10 to the delivery assistance device 40. Therefore, the control device 45 of the delivery assistance device 40 can acquire the location candidates and the priority ranks for the location candidates in a state of being associated with each other. When there are two or more location candidates in which the available luggage locker 20 is installed among the location candidates, the control device 45 selects the location candidate having the highest priority rank among the location candidates as the delivery destination. Therefore, according to the delivery assistance method of the present embodiment, a location candidate having a relatively high priority rank can be set as a delivery destination.

(1-3) According to the delivery assistance method of the present embodiment, the delivery destination is set in consideration of the use situation of the plurality of luggage lockers 20. Therefore, a location candidate having a relatively low priority rank may be set as a delivery destination. When a location candidate having a relatively low priority rank is set as the delivery destination, the customer's satisfaction with the service provided by the delivery assistance method is likely to be lower than in a case where a location candidate having a relatively high priority is set as the delivery destination.

In this regard, according to the delivery assistance method of the present embodiment, an incentive is given to a customer who has used the present service. Specifically, the control device 45 of the delivery assistance device 40 calculates the incentive such that the incentive is higher as the priority rank of the location candidate selected as the delivery destination is lower. Accordingly, even in a case where a location candidate having a relatively low priority rank is set as a delivery destination, it is possible to suppress a decrease in customer satisfaction with the present service.

### Second Embodiment

A second embodiment of the delivery assistance method will be described with reference to FIG. 4. In the second embodiment, the content of the delivery destination determination process is different from that of the first embodiment. In the following description, portions different from those of the first embodiment will be mainly described, and the same member configurations as those of the first embodiment will be denoted by the same reference numerals, and redundant description will be omitted.

With reference to FIG. 4, the process of determining the delivery destination of the step S113 will be described.

In step S11, the control device 45 of the delivery assistance device 40 searches for an available luggage locker 20 among the luggage lockers 20 that have transmitted locker information.

In the next step S13A, the control device 45 selects the luggage locker 20 having the lowest use ratio among the available luggage lockers 20. In the subsequent step S15, the control device 45 selects the installation location 20A at which the luggage locker 20 selected in step S13A is installed as the delivery destination. Thereafter, the control device 45 ends the determination process.

According to the present embodiment, the following effects can be further obtained in addition to the operations and effects equivalent to the effects (1-1) and (1-3) of the first embodiment.

(2-1) When there are two or more location candidates in which the available luggage locker 20 is installed, the control device 45 selects the location candidate in which the luggage locker 20 having the lowest use ratio is installed as the delivery destination. Therefore, according to the delivery assistance method of the present embodiment, it is possible to suppress the occurrence of the deviation of the use ratio between the plurality of luggage lockers 20.

### Modification

The embodiment described above may be modified as follows. The embodiment and the following modified examples may be combined within a scope in which the combined modified examples remain technically consistent with each other.

In the first embodiment and the second embodiment, giving an incentive to a customer is not essential.

In the second embodiment, it is not essential to cause the customer to set priority ranks for a plurality of location candidates.

The control device 45 is not limited to a device that includes a CPU and a ROM and executes software processing. That is, the control device 45 may be a processing circuitry having any one of the following configurations

(a) The control device 45 includes one or more processors that execute various processes in accordance with a computer program. The processor includes a CPU and memories such as a RAM and a ROM. The memory stores program codes or instructions configured to cause the CPU to execute processes. Memory, or computer-readable media, includes any available media that can be accessed by a general purpose or special purpose computer.

(b) The control device 45 includes one or more dedicated hardware circuits that execute various processes. Dedicated hardware circuitry may include, for example, an application-specific integrated circuit, or ASIC, or an FPGA. ASIC is an abbreviation of “Application Specific Integrated Circuit”, and FPGA is an abbreviation of “Field Programmable Gate Array.”

(c) The control device 45 includes one or more processors that execute some of various processes in accordance with a computer program, and one or more dedicated hardware circuits that execute the remaining processes of the various processes.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A delivery assistance method for assisting a delivery person in delivering luggage addressed to a customer who receives a luggage delivery service to a luggage locker installed at a location designated by the customer, the delivery assistance method, comprising:
acquiring, with processing circuitry, location candidates selected by the customer as a candidate for a pickup location of the luggage;
acquiring, with the processing circuitry, locker information including availability of the luggage locker installed at each of the location candidates;
selecting, with the processing circuitry, a location candidate at which the luggage locker is available from the location candidates as a delivery destination of the luggage based on the locker information; and
notifying, with a communication device, the customer of the delivery destination, which is selected by the processing circuitry.

2. The delivery assistance method according to claim 1, wherein
the acquiring the location candidates with the processing circuitry includes acquiring the location candidates selected by the customer and priority ranks set by the customer for the location candidates, the location candidates and the priority ranks being associated with each other, and
the selecting the delivery destination with the processing circuitry includes, when the luggage locker is available at two or more of the location candidates, selecting a location candidate having a highest priority rank among the two or more of the location candidates as the delivery destination.

3. The delivery assistance method according to claim 2, further comprising:
calculating an incentive provided to the customer with the processing circuitry,
wherein the calculating the incentive with the processing circuitry includes calculating the incentive such that the incentive is increased as the location candidate selected as the delivery destination has a lower priority rank.

4. The delivery assistance method according to claim 1, wherein the selecting the delivery destination with the processing circuitry includes, when the luggage locker is available at two or more of the location candidates, selecting a location candidate at which the luggage locker has a lowest use ratio among the two or more of the location candidates as the delivery destination.
